(19) United States
(12) Patent Application Publication
(10) Pub. No.: US 2003/0170441 A1
(43) Pub. Date: Sep. 11, 2003

(54) Composite-structure core

(76) Inventor: Frederick P. Boyle, Kirtland, OH (US)

Correspondence Address: Frederick P. Boyle, 8930 Riverwood Way, Kirtland, OH, 44094-9376, US

(21) Appl. No.: 10/090,577

(22) Filed: Mar. 5, 2002

(51) Int. Cl. B32B 27/04

(52) U.S. Cl. 428/297.4

(57) ABSTRACT

Fiber-polymer-composite structure core includes array of unidirectional fiber-columns that can be optimized for structure robustness and/or weight. The unidirectional columns extend through the core between at-least-perpendicular core surface sections in a manner that allows the columns to bond to—and to transfer forces between—composite-structure skin-sections. The columns can be fiber-polymer composite, all fiber, or all fiber that become fiber-polymer composite when a cored composite structure is produced.

### CROSS-REFERENCE TO RELATED APPLICATIONS

Not Applicable

### STATEMENT REGARDING FEDERALLY SPONSERED RESEARCH OR DEVELOPMENT

Not Applicable

### COMPACT DISK APPENDIX

Not Applicable

### BACKGROUND OF THE INVENTION

Present invention relates to cores used in fiber-reinforced polymer composite structures and in particular to cores used in robust composite structures designed for low weight.

Use of fiber-reinforced polymer composites for robust structures is well known. High-strength fibers, e.g. glass, carbon, Kevlar® or polyester, are bonded in desired structure shape by a polymer. Most often the polymer is a thermoset, e.g. epoxy, which coats fibers when liquid and cures to a solid. The polymer, however, can also be a thermoplastic, e.g. polyamide, which coats fibers when melted and cools to a solid.

Many applications desire composite structures with low weight, i.e. low mass. Minimum weight is often limited in a construction method that achieves structure stiffness by increasing composite wall thickness beyond that needed for structure strength. A lighter weight alternative is “cored” construction where relatively low-density core separates and bonds relatively thin skin sections. Skin sections provide structure strength and core provides structure stiffness by increasing wall thickness and transferring steady state and transient stiffening forces between skin sections. Hence, as used herein, a cored composite structure is a structure that meets strength and stiffness requirements with minimal weight by having fiber-reinforced-polymer skin sections on surface sections of a core that is capable of transferring forces between the skin sections.

A cored composite structure can be an essentially 2-dimensional panel, which has length and width substantially greater than thickness, e.g. a boat hull, where core, with essentially uniform thickness, stiffens by transferring forces between skin sections, typically two separate skins, on opposite core surfaces. That is, the core transfers forces between skin sections on surfaces with essentially 180° angle between normal-vectors. (A normal vector is perpendicular to—and pointed away from—a surface.)

A cored composite structure can also be 3-dimensional where core stiffens by transferring forces between skin sections, often sections of a single skin, on core surfaces with other than 180° angle between normal-vectors. For example, cylindrical-shaped core can stiffen a single-skin, rod-shaped composite structure by transferring compressive and shear forces from one skin section to not only the skin section on opposite end of core diameter, but to all skin on opposite half of core circumference. As another example, rectangle-shaped composite structure ribs or stringers often have skin on three surfaces of a core that transfers significant compressive and shear forces between perpendicular skin sections.

In general, a core can weight-efficiently stiffen a composite structure if integral skin sections are on core surface sections that are at least perpendicular; i.e. where relative normal vectors are 90° or greater.

Forces transferred by a core in a cored composite structure can be substantial. Hence in addition to low density, a proper core must bond adequately with skin sections and must have adequate tensile, compressive and shear strengths and moduli. Ideally, a core has high, anisotropic, specific strengths and moduli that can be aligned by composite structure designer or manufacturer for maximum benefit. A cored composite structure's skin sections do not, under normal use, permanently deform. Hence under normal use, a proper core must not permanently deform from high impact or when transferring high forces for extended periods. A cored composite structure's skin sections are typically designed to provide long, stable performance in a wide variety of environments. Hence, a proper core's strength, dimension or weight must not change due to aging or environment, and thermal expansion coefficient should be similar to skin materials.

Current art typically uses plywood, balsa wood, closed-cell polymer foams, and various honeycombs as cores in fiber-polymer composite structures.

Plywood is a relatively low cost core with high strengths and moduli. Plywood's relatively high density, however, limits weight savings. Plywood is used primarily in low-cost cored composite structures or in limited locations where skin surfaces are relatively flat and high strength is needed.

Balsa wood has relatively high specific strengths and moduli that, due to grain structure, are anisotropic. However, since balsa core typically has grain aligned in only one direction, designer/manufacturer flexibility in aligning strengths for maximum benefit is limited. Being a natural material, balsa's properties are not easily controlled, and even with costly selection of lightest materials, balsa's density is greater than that achievable with foam and honeycomb cores. Balsa, while relatively stable, is affected by water. Due to accident or poor construction, balsa can have long-term weight and dimensional changes in structures for wet environment. When used in a curved structure, small blocks of balsa are held together on one side by fabric that allows blocks to rotate and conform. A shortcoming of this is that, during production, gaps between rotated blocks either fill with polymer, reducing weight savings, or do not fill with resin, allowing path for water migration if a skin is punctured.

A variety of thermoplastic and thermoset foams, which are typically more stable than balsa in wet environment, are controllably manufactured to low densities. Thermoplastic foams can be shaped for a curved-surface structure by heating, eliminating need to section the material. Thermoset foams are sectioned like balsa, except that by cutting only partially through foam thickness blocks can rotate without need for fabric. Foams, however, have limited anisotropy, relatively low strength and high thermal expansion, and when used in applications with extended high forces and/or high impact, can have deformation issues, especially at elevated temperatures.

Honeycombs are controllably manufactured with very low densities and with anisotropic strengths and moduli. As with balsa, flexibility for aligning strengths for maximum benefit is limited. Honeycombs are available with long-term stability in all environments. For many applications, however, honeycombs are not cost effective because of substantially higher price for appropriate materials and typically greater installation labor when compared to balsa and foam cores.

In addition to above issues, plywood, balsa, foams and honeycombs can each have long-term bonding issues, particularly if transient tensile forces occur between skin sections.

Due to these and other issues, current art limits robustness and/or minimum weight achievable in cost-effective cored composite structures. In particular, in structure areas with high forces, designer/manufacturer often either does not use weight saving core, or uses higher cost cores and/or production methods.

Present invention overcomes limitations of previous cores. Present invention allows design of cost and weight effective cores/cored-composite-structures by aligning anisotropic, high specific-strength/modulus columns to optimize composite structure robustness and weight for particular applications. Present invention solves bonding, deformation, stability, and thermal expansion problems of previous cores by using material that is same or similar to that of composite structure skin sections in the high strength columns.

### SUMMARY OF THE INVENTION

Present invention is a composite-structure core comprised of an array of unidirectional fiber-columns that extend through the core between at-least-perpendicular core surface sections, and a core-material, with the at-least-perpendicular core surface sections, that holds the columns until cored-composite-structure production and that allows the columns to bond to—and become capable of transferring force between—fiber-reinforced-polymer skin-sections during structure production.

Ideally, a unidirectional fiber-column is straight as it extends through a core. However, some column curvature may occur during column, core and/or core composite structure production. Hence as used herein, a unidirectional fiber-column is one where length of shortest line that can be drawn within the column between core surface sections is less than 102% of straight line length between ends of above described shortest line.

As used herein, a unidirectional fiber-column extends between at-least perpendicular core surface sections when angle between normal vectors of surface sections at ends of shortest line that can be drawn within the column between core surface sections is 90° or greater.

As used herein, core-material: 1) has appropriate physical and chemical properties for cored-composite-structure production temperatures, pressures and chemicals, 2) is essentially continuous, i.e. not segmented except as needed to allow core to conform to curved surfaces or to limit size for shipping and/or handling, and 3) includes, other than the columns, all materials and open space, which can be filled with polymer during core-composite-structure production, in a core.

An invention feature is that core-material can bond to—and become capable of transferring forces between—, and have average density less than the density of—composite skin sections placed, e.g. molded, on core surface sections when a cored composite structure is produced.

Another invention feature is that core-material can be substantially removed from the core after unidirectional fiber-columns are bonded to skin sections of cored composite structure. As used herein core-material is substantially removed if typically greater than 50%, preferably greater than 75%, and more preferably greater than 90% by weight of the material is removed.

Another invention feature is that columns can be fiber-polymer composite, which can include either a thermoset or thermoplastic polymer.

Another invention feature is that columns can be fibers in a hole through core-material that become fiber-polymer composite columns when filled with polymer during cored-composite-structure production. As used herein a hole is a conduit or open shaft.

Another invention feature is that core-material can include channels that aid in filling fibers-in-a-hole columns with polymer during cored-composite structure production.

Another invention feature is that columns can be fibers with no polymer, i.e. all-fiber.

Another invention feature is that a column end can bond to a skin section with a secondary bond when cored composite structure is produced. A secondary bond occurs when polymer bonding adjacent components, e.g. column ends and skin sections, is applied and hardened at different time than the polymer in one or both components.

Another invention feature is that fibers extending from a column end can bond to—and become part of—a skin section with a secondary bond when cored composite structure is produced.

Another invention feature is that fibers extending from a column end can bond to—and become part of—a skin section with a primary bond when cored composite structure is produced. A primary bond occurs when polymer in adjacent components, e.g. fiber extensions and skin fiber layer(s), is applied and hardened at same time.

Another invention feature is that column array can be designed for an optimum performance, e.g. minimum weight, of cored composite structure, or can be designed including practical considerations, e.g. cost.

Another invention feature is that column array can have uniform or non-uniform unidirectional fiber-column size, shape, spacing, fiber content, and angle relative to core surface sections. As used herein, a column's fiber content includes fiber material-type, diameter, length, orientation and number, and if a fiber-polymer composite, polymer material type and concentration, i.e. volume or weight percent.

Another invention feature is that unidirectional fiber-columns can intersect.

Another invention feature is that columns preferably have a minimum cross-section area less than square of length of shortest line that can be drawn within the column between core surface sections.

Another invention feature is that columns more preferably have a minimum cross-section area less than 0.25 times square of length of shortest line that can be drawn within the column between core surface sections.

Another invention feature is that skin sections can be sections of one skin or of separate skins that are integral part of a cored composite structure.

Another invention feature is that the skin sections can include either a thermoset or thermoplastic polymer.

The foregoing and other objects and features of present invention will become apparent from following description made with reference to drawings.

### BRIEF DESCRIPTION OF THE DRAWINGS

FIG. 1 is a schematic drawing of an invention embodiment with unidirectional fiber-columns, comprised of fiber-polymer composite, that are perpendicular to opposite and parallel core surfaces.

FIG. 2 is a schematic drawing showing one method for producing invention embodiment of FIG. 1.

FIG. 3 is a schematic drawing showing examples of unidirectional fiber-polymer-composite columns.

FIG. 4 is a schematic drawing showing another method for producing invention embodiment of FIG. 1.

FIG. 5 is a schematic drawing of another invention embodiment with unidirectional fiber-columns comprised of fiber-polymer composite, with fibers extending from column ends for bonding to—and becoming part of—composite structure skin sections.

FIG. 6 is a schematic drawing showing one method for producing invention embodiment of FIG. 5.

FIG. 7 is a schematic drawing of an invention embodiment with unidirectional fiber-columns comprised of fiber bundles in holes that can fill with polymer.

FIG. 8 is a schematic drawing showing one method for producing invention embodiment of FIG. 7.

FIG. 9 is a schematic drawing showing another method for producing invention embodiment of FIG. 7.

FIG. 10 is a schematic drawing showing core of FIG. 9 bent.

FIG. 11 is a schematic drawing showing another method for producing invention embodiment of FIG. 7.

FIG. 12 a schematic drawing of an invention embodiment with unidirectional fiber-columns comprised of fibers.

FIG. 13 is a schematic drawing showing one method for producing invention embodiment of FIG. 12.

FIG. 14 is a schematic drawing of an invention embodiment with fibers extending from unidirectional fiber-column ends holding fiber layers to core surface.

FIG. 15 is a schematic drawing showing a method for producing invention embodiment of FIG. 14.

FIG. 16 is a schematic drawing of an invention embodiment with elliptically shaped unidirectional fiber-columns.

FIG. 17 is a schematic drawing of an invention embodiment with unidirectional fiber-columns that are not perpendicular to core surfaces.

FIG. 18 is a schematic drawing showing a method for producing invention embodiment of FIG. 17.

FIG. 19 is a schematic drawing showing core of FIG. 18 bent.

FIG. 20 is another schematic drawing showing core of FIG. 18 bent.

FIG. 21 is a schematic drawing of an invention embodiment similar to embodiment of FIG. 17 except with different relative column positions.

FIG. 22 is a schematic drawing of an invention embodiment similar to embodiment of FIG. 17 except with column type, fiber-polymer-composite instead of fiber-in-hole.

FIG. 23 is a schematic drawing of an invention embodiment with channels for filling unidirectional fiber-columns with polymer as cored composite structure is produced.

FIG. 24 is a schematic drawing of an invention embodiment with unidirectional fiber-column array that includes both fiber-polymer-composite and all-fiber columns.

FIG. 25 is a schematic drawing of an invention embodiment with array of intersecting unidirectional fiber-columns.

FIG. 26 is a schematic drawing of an invention embodiment with core-material that can be substantially removed after columns are bonded to skin sections.

FIG. 27 is a schematic drawing of an invention embodiment in a cored composite structure with parallel skins.

FIG. 28 is a schematic drawing of an invention embodiment in a cored composite structure with curved skins.

FIG. 29 is a schematic drawing of an invention embodiment in a cored composite structure with core-material substantially removed.

FIG. 30 is a schematic drawing of an invention embodiment with array where column size and spacing varies.

### DETAILED DESCRIPTION OF THE INVENTION

Present invention is a composite-structure core comprised of an array of unidirectional fiber-columns that extend through the core between at-least-perpendicular core surface sections, and a core-material, with the at-least-perpendicular core surface sections, that holds the columns until cored-composite-structure production and that allows the columns to bond to—and become capable of transferring force between—fiber-reinforced-polymer skin-sections during structure production. Various features and embodiments are described below by way of non-limiting illustration.

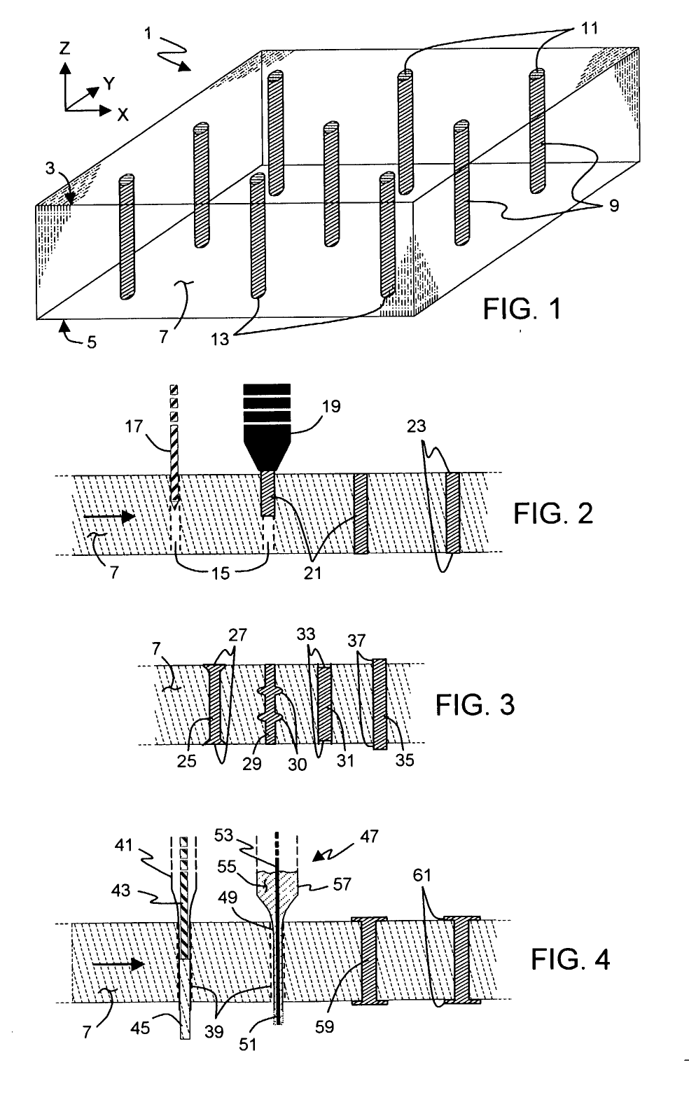

FIG. 1 shows a schematic drawing of an embodiment of present invention. Core 1 is for use in cored composite structures where fiber-reinforced skin sections are place, e.g. molded, onto parallel upper surface 3 and lower surface 5 that extend in X-Y planes (defined by axes in the figure). Core 1 is comprised of core-material 7 and array of unidirectional fiber-columns 9 aligned in Z-direction perpendicular to surfaces 3, 5. Core-material 7 defines core surfaces 3, 5 and holds columns 9 in position until the columns bond to skin sections during production of a cored composite structure. Material 7 is intended to remain in—and be of benefit to—a cored composite structure. Material 7 is preferably low-density material that can bond with skin sections. Material 7 is more preferably very low-density closed-cell polymer foam that can withstand pressures and temperatures of cored-composite-structure production without unacceptable deformation, but can be shaped to curved structure surfaces without sectioning, e.g. by heating and/or force. Note: in this and other schematic drawings, material 7 is transparent to allow viewing of invention details. Columns 9 are comprised of fibers in harden polymer, i.e. fiber-polymer composite, that can transfer tensile, compressive and/or shear forces between column ends 11, 13. Length of columns 9 equals material 7 thickness with ends 11, 13 exposed on and even with surfaces 3, 5 respectively. This positioning allows ends 11, 13 to easily form secondary bonds with adjacent skin sections during production of a cored composite structure. When ends 11, 13 are so bonded, columns 9 are capable of transferring forces between skin sections.

Present invention does not require total length of fiber-polymer composite columns 9 equal material 7 thickness. An invention embodiment similar to core 1 of FIG. 1 can have unidirectional fiber-column length less than material 7 thickness, e.g. column 31 in FIG. 3. Shorter length may be desirable to allow for dimension variations that might otherwise cause columns to extend beyond material 7, or to allow for some deformation of material 7 during composite structure production. However, even with shorter length, column ends 33 of columns 31 must be exposed and must be in sufficiently close to material 7 surfaces to allow bonding with skin sections during composite structure production. An invention embodiment similar to core 1 of FIG. 1 can have total composite column length greater than material 7 thickness, e.g. column 35 in FIG. 3. Unidirectional fiber-column 35, which extends between material 7 surfaces, has extended ends 37 which contain fibers in a hardened polymer extending beyond the column, i.e. beyond material 7 surfaces. Extended ends 37, which need not be unidirectional with column 35, provide additional area and become part of a skin molded onto material 7, thereby providing benefit in bonding column 35 to the skin section.

FIG. 2 shows a schematic drawing of one method for producing core 1 of FIG. 1. Core-material 7 moves incrementally, at displacements equal to column spacing, along a production line (entire line not shown) in direction shown by arrow. With material 7 stopped, a hole 15 is formed by drill 17 (shown withdrawing from core), and simultaneously device 19 inserts a column 21 (shown with column partially inserted) into a previously formed hole 15. Unidirectional fiber-columns 21 are fiber-polymer composite that can have continuous fibers, e.g. a pultrusion, or relatively short chopped-fibers. In any case, columns 21 are designed with appropriate size, i.e. diameter, and fiber content to meet strength and modulus requirements. Columns 21 are positioned with ends 23 even with material 7 surfaces. Columns 21 have diameter greater than drill 17 to allow friction fit in holes 15. Friction fit allows material 7 to retain columns 21 during handling, particularly if the core is to be shaped to curved surfaces by heating and/or force. Alternatively, columns 21 can be retained by coating the columns with adhesive either before or as the columns are inserted into material 7, or if columns 21 have sufficiently small diameter, device 19 can insert the columns without holes 15 to achieve friction fit. In any case, ends 23 must be exposed at material 7 surfaces. In alternative invention embodiments, column shape other than regular-cylinder of columns 21 can be used to allow retention of columns in material 7. For example, column 29 of FIG. 3 has sections 30 with diameter greater than drill 17 that provide friction fit. As another example, column 25 of FIG. 3, which has midsection with same diameter as drill 17, has ends 27 with greater diameter to mechanically hold the column in the hole. With proper column design and material 7 elastic properties, column 25 can be inserted in one piece; otherwise one or both ends 27 can be bonded to column 25 midsection in a secondary operation.

Referring further to FIG. 2, after each hole 15 is drilled and each column 21 is inserted, material 7 is moved next incremental distance and hole-forming/column-inserting cycle is repeated. While the figure shows only single hole 15 being formed and single column 21 being inserted with each move of material 7, a production line can form multiple holes and insert multiple columns with each move.

FIG. 4 shows a schematic drawing of another method for producing core 1 of FIG. 1. As in FIG. 2, core-material 7 moves incrementally along a production line in direction shown by arrow. With material 7 stopped, a hole 39 is formed by punch 41 (shown in “down” position). Punch 41 includes pusher 43 that ejects hole material 45 from the punch (shown with hole material partially ejected). Concurrent with hole 39 being formed, device 47 (shown in “down” position) inserts neck 49 into a previously formed hole 39. Extending beyond neck 49 is end 51 of thread 53. As used herein, a thread is a bundle of individual fibers that can reinforce polymer. Thread 53, supplied from a continuous spool (not shown), is coated with either liquid thermoset—or melted thermoplastic—polymer 55 as it passes through reservoir 57. With device 47 in down position, a mechanism (not shown), grasps and holds polymer-coated thread end 51 as device 47 with neck 49 is removed from hole 39, leaving fiber-polymer composite column 59 filling the hole. When device 47 is in “up” position, a second mechanism (not shown) cuts thread 53 leaving a new end 51 extending beyond neck 49, and presses extended polymer-coated ends 61 of column 59, which extend outside hole 39, to surface of material 7. Release paper (not shown) holds ends 61 against material 7 and fiber-polymer composite column 59 in hole 39 until polymer hardens. While thread 53 can be positioned and cut by above-described mechanism so that essentially no ends 61 extend beyond columns 59, the ends are of benefit for holding columns 59 in holes 39 during handling, and for providing additional bonding area when core is used to produce a cored composite structure.

While FIG. 4 shows only single hole 39 being formed and fiber-polymer composite column 59 being placed with each move of material 7, multiple holes and columns can be formed and placed with each move.

Referring again to FIG. 1, to design core 1 for an optimum cored-composite-structure performance, e.g. minimum weight, knowledge is needed of an application's physical requirements, of physical properties and bond strengths of potential skin sections, core-materials 7 and unidirectional fiber-columns 9, and of potential processes for producing the cored composite structure. Often however, in addition to physical requirements, which may prefer core 1 to have array of relatively closely-spaced, small-diameter columns 9 with extended ends, which contain high volume fraction of continuous, very-high-modulus fibers in premium thermoset polymer, and to have extremely low-density material 7, proper design must also consider practical requirements, e.g. cost. Practical requirements may prefer core 1 to have array of less closely-spaced, larger-diameter columns 9 without extended ends, which contain lower volume fraction of lower-cost fibers in lower priced polymer, and to have easier-handled, lower-cost material 7. Although there is typically no one unique core 1 design for a particular application, preferred minimum cross-section area of perpendicular unidirectional fiber-columns 9 is less than the core thickness squared, and more preferred minimum cross-section area of perpendicular columns 9 is less than 0.25 times the core thickness squared. With proper design unidirectional fiber-columns 9 allow core 1 to substantially improve at least one property of a cored composite structure, relative to a structure where same core-material 7 is used without the columns.

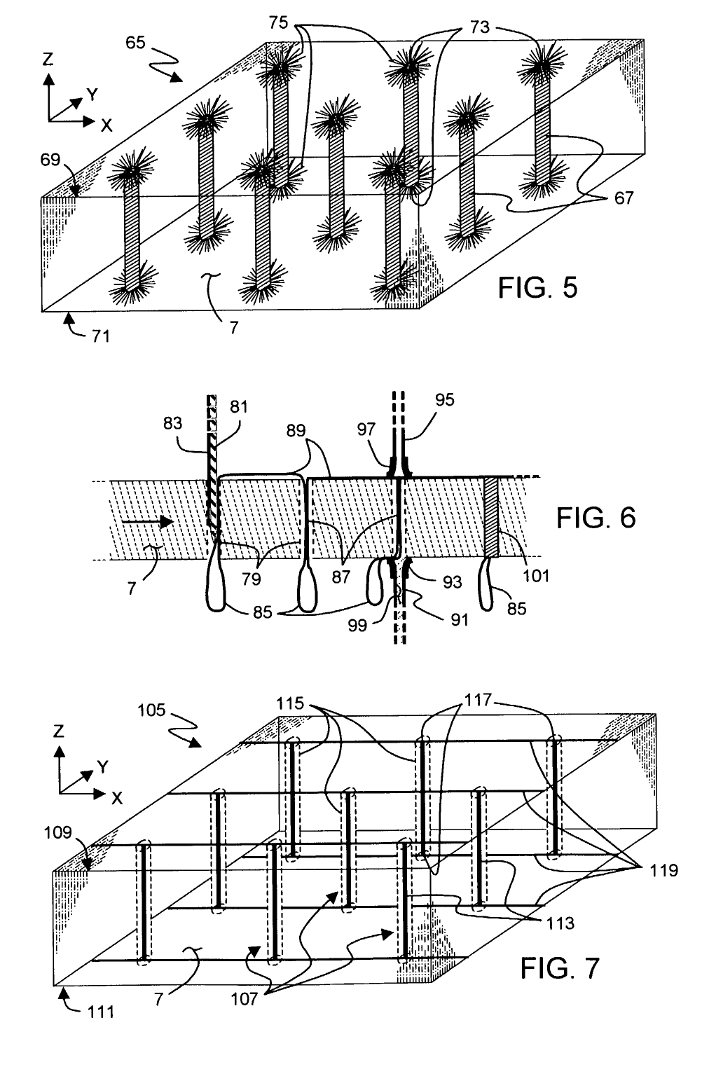

FIG. 5 shows a schematic drawing of another embodiment of present invention. Core 65 is comprised of core-material 7 and array of unidirectional fiber-columns 67 aligned in Z-direction perpendicular to opposite and parallel surfaces 69, 71. Columns 67 are comprised of fiber-polymer composite that can transfer tensile, compressive and/or shear forces between column ends 73. Length of columns 67 between ends 73 equals material 7 thickness. Extending from ends 73 are fibers 75 from columns 67. When core 65 is used to produce a cored composite structure, fibers 75 form either primary or secondary bonds, depending on production process, with—and become part of—composite structure skin sections so that columns 67 are capable of transferring forces between skin sections.

FIG. 6 shows a schematic drawing of one method for producing core 65 of FIG. 5. Material 7 moves incrementally along a production line and, when stopped, a hole 79 is formed by needle 81 (shown withdrawing from core). Passing through eye (not shown) of needle 81 is thread 83 supplied from a continuous spool (not shown). When needle 81 is at lowest position through material 7, a mechanism (not shown) grasps thread 83 and forms and holds loop 85 as needle 81 is removed from hole 79. With needle 81 removed, fiber bundle 87, comprised of two lengths of thread 83, remains in hole 79, and as material 7 moves incremental distances, segments 89 of continuous thread 83 are placed between bundles 87. Concurrent with needle 81 forming hole 79, polymer supply tube 91 with seal 93 and vacuum tube 95 with seal 97 contact (shown) material 7 on opposite sides of a previously formed hole 79 with bundle 87. Tube 95 removes air from hole 79 and tube 91 supplies a metered volume of polymer 99, which can be either liquid thermoset or melted thermoplastic, to coat bundle 87 fibers while filling hole 79. Tubes 91, 95 with seals 93, 97 respectively are then removed from material 7 surfaces and release paper (not shown) holds polymer 99 in hole 79 until fiber-polymer composite column 101 hardens. Columns 101 correspond to unidirectional fiber-columns 67 of FIG. 5, and polymer-free loops 85 and segments 89 correspond to fibers 75 extending from ends 73 of columns 67 of FIG. 5. After a hole 79 is formed, bundle 87 is placed and another hole 79 is filled with polymer 99, material 7 is moved next incremental distance and the cycle repeated.

While FIG. 6 shows only single needle 81, polymer supply tube 91 and vacuum tube 95, multiple needles and tubes can be used to more rapidly produce core.

Referring again to FIG. 5, to design core 65 for an optimum performance, e.g. minimum weight, knowledge is needed of an application's physical and practical requirements and of potential materials and processes for producing a cored composite structure. Preferred minimum cross-section area of perpendicular columns 67 is less than core 65 thickness squared, and more preferred minimum cross-section area of the perpendicular columns is less than 0.25 times the core thickness squared. With proper design unidirectional fiber-columns 67 allow core 65 to substantially improve at least one property of a cored composite structure, relative to a structure where same core-material 7 is used without the columns.

FIG. 7 shows a schematic drawing of another embodiment of present invention. Core 105 is comprised of core-material 7 and array of unidirectional fiber-columns 107 aligned in Z-direction perpendicular to opposite and parallel surfaces 109, 111. Columns 107 are comprised of fiber bundles 113 in holes 115 that extend through material 7 between surfaces 109, 111. Extending from ends 117 and continuations of fibers in bundles 113 of columns 107 are segments 119. When core 105 is used to produce a cored composite structure, holes 115 with bundles 113 typically fill with polymer making columns 107 fiber-polymer composites, and segments 119 form either primary or secondary bonds, depending on production process, with composite structure skin sections, so that columns 107 can transfer forces between skin sections.

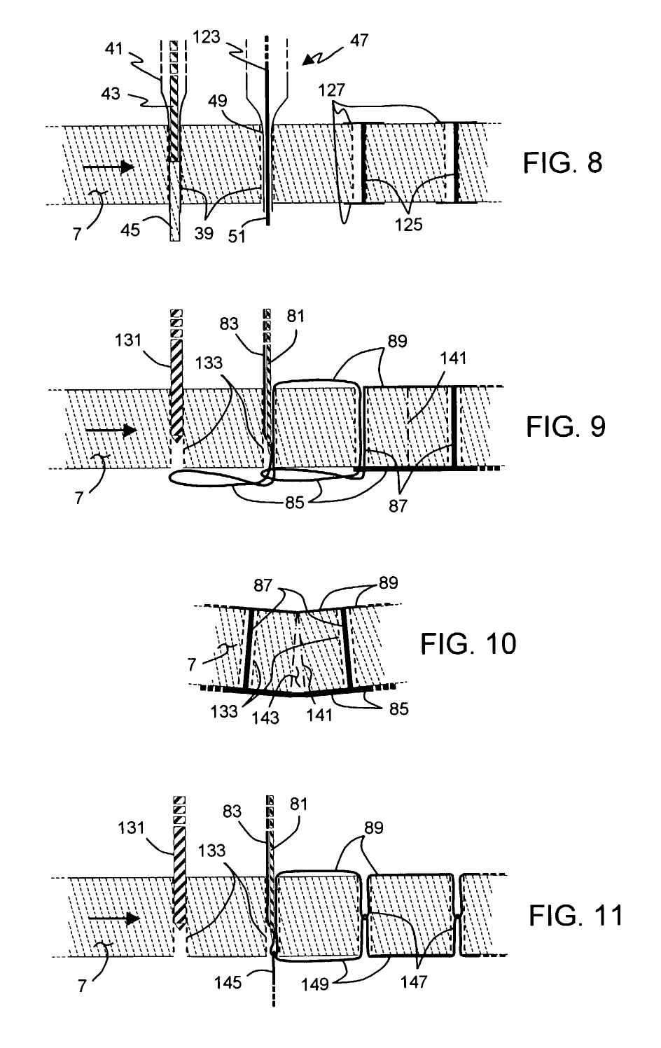

FIG. 8 shows a schematic drawing of one method for producing core 105 of FIG. 7. Similar to—and labeled same as—FIG. 4, material 7 moves incrementally along a production line and, when stopped, punch 41 forms a hole 39 in the material. Concurrent with forming a hole 39, device 47 inserts neck 49 into a previously formed hole. Extending beyond neck 49 is end 51 of thread 123. Thread 123 is supplied with adhesive coating from a continuous spool, so that unlike thread 53 of FIG. 4 no polymer is added as the thread passed through device 47. When device 47 with neck 49 is in “up” position, a second mechanism cuts thread 123 leaving a new end 51 extending beyond neck 49. Fiber bundle 125, which remains in hole 39 and corresponds to fiber bundle 113 of FIG. 7, is forced by the second mechanism to side of hole 39. Fiber segments 127, which extend beyond hole 39, are pressed by the second mechanism to material 7 surfaces. Adhesive coated bundles 125 and segments 127 form temporary bonds with material 7 so that the core can be handled without fiber loss until used in production of a cored composite structure. During structure production, temporarily bonded bundles 125 release as polymer typically fills holes 39 allowing bundle fibers to reinforce the polymer. Similarly, temporarily bonded segments 127 release during composite structure production allowing segment fibers, while not extending between fiber bundles in manner shown for segments 119 of FIG. 7, to serve same function of forming either primary or secondary bonds, depending on production process, with skin sections.

While FIG. 8 shows only single hole 39 being formed and bundle 125 being place with each move of material 7, multiple holes and fiber bundles can be formed and placed with each move.

Core 105 of FIG. 7 can also be produced in manner similar to FIG. 6 where thread 83 in FIG. 6 is supplied from continuous spool with adhesive already applied to temporarily bond bundles 87, segments 89 and loops 85 to material 7, without need for tubes 91, 95 and polymer 99.

FIG. 9 shows a schematic drawing of another method for producing core 105 of FIG. 7. Material 7 moves incrementally along a production line and, when stopped, drill 131 forms hole 133. Note: use of a drill or a punch typically results in forming a well-defined hole since material 7 is removed from the hole. Due to material not being removed and due to elastic properties of many materials 7, a hole formed by a needle, e.g. hole 79 formed by needle 81 of FIG. 6, can be less well defined. With continued reference to FIG. 9, simultaneous with drill 131 forming hole 133, needle 81 with thread 83 (labeled same as FIG. 6) and a mechanism form loop 85 and place fiber bundle 87. However unlike core of FIG. 6 where loop 85 remains free, in this method needle 81 passes through loop 85 formed during previous fiber-placement cycle so that newly formed loop 85 locks previous loop in manner known in single-thread sewing machine art. Also shown are fiber segments 89 of continuous thread 83 that extend between bundles 87. Hence, loops 85 and segments 89 hold bundles 87 in holes 133 until the core is used in a cored composite structure. If core produced by this method is to be used only in structures with flat surfaces, loops 85 can be sized so that length of thread 83 in the loops equals twice distance between bundles 87. However, if core may be used in a curved-surface structure, then loops 85 need additional length of thread 83 to allow shaping the core as will now be explained.

FIG. 10 shows a schematic drawing of core of FIG. 9 bent at cut 141 in manner that might be used to shape the core to a curved surface. Bend angle at cut 141 is a function of curved-surface radius; angle increases with decreasing radius. Distance between bundles 87 on top core-surface remains essentially same as that of unbent core. However, distance between bundles 87 on bottom core-surface, the outside radius, is increased for bent core due to gap 143, which has effectively increased the core's core-material (as previously defined). Hence in bent core, loop 85 must have sufficient additional length of continuous thread 83 to allow the core to bend to a designed minimum radius. Typically, even if material 7 can be shaped without sectioning, e.g. by heating, distance between bundles 87 increases on the outside radius. Thus, appropriate loop 85 length must be determined when designing core for curved-surface structures.

FIG. 11 shows a schematic drawing of another method for producing core 105 of FIG. 7. Material 7 moves incrementally along a production line and, when stopped, drill 131 forms a hole 133 and simultaneously needle 81 with thread 83 supplied from a continuous spool enters a previously formed hole 133. When needle 81 is at lowest position, a mechanism (not shown, but known in sewing machine art) grasps and loops thread 83 around a second thread 145, which is supplied from a second continuous spool (not shown). When needle 81 is removed from material 7, hole 137 contains fiber bundle 147. As shown in the figure, fiber content of bundle 147 is a “U”-shaped length of thread 83 interlocked with a “U”-shaped length of thread 145, such that number of fibers in upper section of bundle is twice number of fibers in thread 83, and number of fibers in lower section of the bundle is twice number of fibers in thread 145. However, depending on how threads 83, 145 are held and tensioned, interlock between the threads can occur on a surface of material 7 such that fiber content of bundle 147 is essentially two lengths of thread 83 or thread 145. In any case, segments 89 of thread 83 are on top surface and segments 149 of thread 145 are on bottom surface of material 7 between bundles 147. If core produced by this method is to be used only in flat cored-composite-structures, then segments 89, 149 need length only equal to distance between bundles 147. However, if core may be used in a curved-surface structure, then segment 89 and/or 149 need to be of sufficient length to allow the core to bend to designed minimum radius.

Referring again to FIG. 7, to design core 105 for an optimum cored-composite-structure performance, knowledge is needed of physical and practical requirements of the particular application and of potential materials and processes for producing the structure. Preferred minimum cross-section area of perpendicular columns 107, that is cross-section area of holes 115, is less than core 105 thickness squared, and more preferred minimum cross-section area is less than 0.25 times the core thickness squared.

Invention embodiments of FIGS. 1 and 5 have unidirectional fiber-columns that are fiber-polymer composites. Invention embodiment of FIG. 7 has unidirectional fiber-columns comprised of fiber bundles in open holes that typically fill with polymer during production of a core composite structure to become fiber-polymer composite columns. Unidirectional fiber-polymer composite columns are particularly advantageous for efficient transfer of tensile, compressive and shear forces. Present invention, however, is not limited to unidirectional fiber-columns that include or allow for hardened polymer. Some applications may require unidirectional fiber-columns that transfer primarily tensile forces. For example, unidirectional fiber-columns might be used to limit tensile force transferred by core-material 7 so as to prevent exceeding the material's tensile or bond strength. In such applications, unidirectional fiber-columns can be all-fiber.

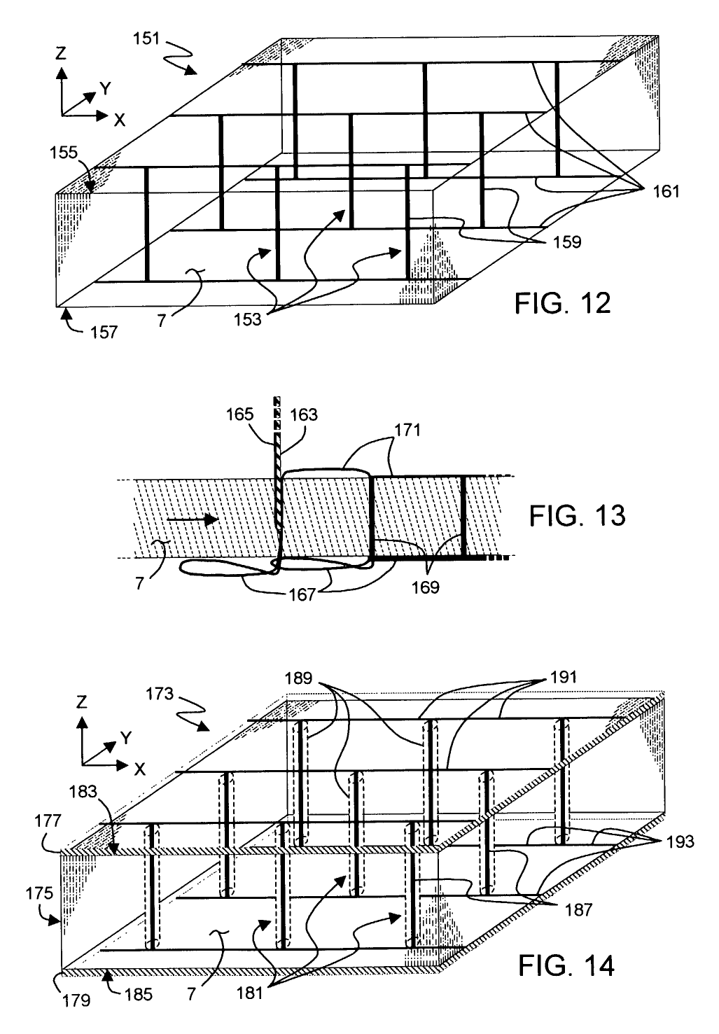

FIG. 12 shows a schematic drawing of another embodiment of present invention. Core 151 is comprised of core-material 7 and array of unidirectional fiber-columns 153 aligned in Z-direction perpendicular to opposite and parallel surfaces 155, 157. Columns 153 are comprised of fiber bundles 159. Unlike embodiment of FIG. 7, columns 153 do not include holes. Extending from columns 153 and continuations of fibers in bundle 159 are fiber segments 161. When core 151 is used to produce a cored composite structure, segments 161 form either primary or secondary bonds, depending on production process, with skin sections so that columns 153 are capable of transferring primarily tensile forces between skin sections.

FIG. 13 shows a schematic drawing of one method for producing core 151 of FIG. 12. Material 7 moves incrementally along a production line and, when stopped, a small diameter needle 163 pierces the material. Needle 163 has thread 165 passing through its eye. When needle 163 is at its lowest position, a new loop 167 is formed which locks previous loop 167 in manner previously described. When needle 163 is removed from material 7, fiber bundle 169, comprised of two lengths of thread 165, remains in the material. Due to small diameter of needle 163 and elastic character of material 7, essentially no open space remains around bundle 169. Also shown are fiber segments 171 of continuous thread 165 that extend between bundles 169. As in discussions for FIGS. 9 and 10, length of thread 165 in loops 167 is dependent on if and how core produced by this method may be used in a cored composite structure with a curved surface. In any case, loops 167 are of sufficient length to meet design requirements.

Referring again to FIG. 12, core 151 can also be produced by two-thread sewing similar to method of FIG. 11 without drill 131. Threads can be properly sized and tensioned to assure designed tensile force can be transferred between the threads. Use of continuous fibers for columns 153 and its extensions, segments 161, however, is preferred.

To design core 151 for an optimum cored-composite-structure performance, physical and practical knowledge is needed of application, materials and production processes. Preferred minimum cross-section area of perpendicular columns 153 is less than core 151 thickness squared; more preferred minimum cross-section area of perpendicular columns is less than 0.25 times the core thickness squared.

Invention embodiments of FIGS. 5, 7, and 12 have fibers extending from unidirectional columns bonding to—and becoming part of—composite structure skin sections at core surface. Present invention is not limited to fibers from columns bonding to—and becoming part—of skin sections at core surface.

FIG. 14 shows a schematic drawing of another embodiment of present invention where fibers extending from unidirectional columns bond to—and become part of—composite structures skin sections at a distance from core surface. Structure 173, which is intended for used in a cored composite structure, is comprised of core 175 and fiber layers 177, 179. As used herein, a fiber layer can be layer of cloth, mat, woven roving or combination of these or other fiber materials used to reinforce a cored-composite-structure skin section. Note: layers 177, 179 are drawn clear except on closest edges to allow viewing of embodiment details. Core 175 is comprised of core-material 7 and array of unidirectional fiber-columns 181 aligned in Z-direction perpendicular to opposite and parallel surfaces 183, 185. Columns 181 are comprised of fiber bundles 187 in holes 189 that extend through material 7 between surfaces 183, 185. Extending between columns 181 and continuations of fibers in bundles 187 are fiber segments 191, 193 that hold layers 177, 179 respectively onto surfaces 183, 185 respectively. When structure 173 is used to produce a cored composite structure, a production method should be used that allows holes 189 and layers 177, 179 to fill with polymer and, if other fiber layers are used in structure skin sections, to bond with other layers. In this manner, segments 191, 193 bond to—and become part of—skin sections outside fiber layers 177, 179 and columns 181 become composite columns capable of transferring forces between skin sections.

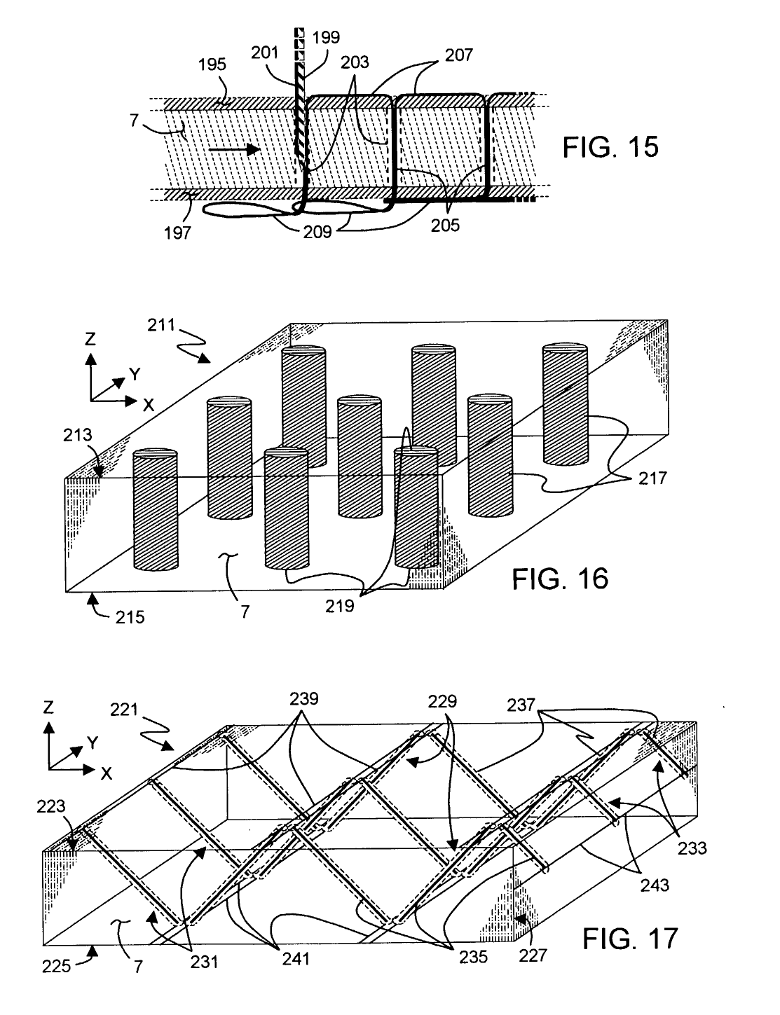

FIG. 15 shows a schematic drawing of one method for producing structure 173 of FIG. 14. As material 7, with fiber layers 195, 197 on top and bottom surfaces respectively, moves incrementally along a production line, a relatively large diameter needle 199 with continuous thread 201 forms holes 203, places fiber bundles 205 in the holes and places fiber segments 207 and loops 209, which hold layers 195, 197 to the material, in a manner known in single-thread sewing machine art.

Structure 173 of FIG. 14 can also be produced by stitching fiber layers to core-material 7 using two continuous threads similar to method shown in FIG. 11.

In general to prevent damage to fiber layers 177, 179 of FIG. 14, either a needle should be used to stitch the layers to material 7, or if holes are made by drill, punch or other method that removes material 7, holes 189 should be formed before layers 177, 179 cover the holes.

In any production process of structure 173, no excess fiber is typically needed for segments 191, 193 since, in general, layers 177, 179 do not stretch. Hence, fiber layers on both core surfaces 183, 185 implies use of structure 173 in essentially flat cored composite structures. If structure 173 may be used in a curved-surface structure, typically only one side of core 175 has fiber layer, and segments 191 and/or 193 have sufficient excess length to allow the core to bend to designed minimum radius.

Invention embodiments shown of FIGS. 1, 5 and 7 have unidirectional fiber-columns with circular cross-section. Columns with circular cross-section typically provide isotropic shear-force transfer properties. There are, however, applications where more appropriate cored composite structure performance might be achieved with columns that have anisotropic shear-force transfer properties.

FIG. 16 shows a schematic drawing of another embodiment of the present invention. Core 211, with opposite and parallel surfaces 213, 215, is comprised of core-material 7 and array of perpendicular elliptical-cross-section unidirectional fiber-columns 217 that extend between the surfaces. Elliptical columns 217 are comprised of fibers in hardened polymer that can transfer tensile, compressive and/or shear forces between column-ends 219. With anisotropic cross section, columns 217 have greater shear modulus and strength along major axis. Hence by aligning all columns 217 with major axis in X-direction, core 211 can provide higher shear modulus and strength in X-direction than Y-direction when the core is used in a cored composite structure.

Invention embodiments similar to those shown in FIGS. 5, 7 and 14 can have elliptical unidirectional fiber-columns. Appropriate holes can be formed with elliptical shaped needles, punches, or by proper motion of machining bits. Other unidirectional fiber column shapes can also be formed. In general, unidirectional fiber-columns can vary in both cross-section shape and area as a function of position along the column to optimize core performance in cored composite structures. However independent of shape, preferred minimum cross-section area of a perpendicular column between parallel core surfaces is less than core thickness squared, more preferred minimum cross-section area is less than 0.25 times core thickness squared.

Previous embodiments show arrays of unidirectional fiber-columns that are perpendicular to parallel core surfaces. Present invention, however, is not limited to perpendicular columns or parallel core surfaces.

FIG. 17 shows a schematic drawing of another invention embodiment. Core 221 has three surfaces intended for skin sections in a cored composite structure: upper surface 223, lower surface 225 which is opposite and parallel to surface 223, and end surface 227, which extends between and is perpendicular to surfaces 223, 225. Core 221 is comprised of core-material 7 and array of unidirectional fiber-columns that includes columns 229 angled from lower left to upper right and columns 231 angled from upper left to lower right between surfaces 223, 225, and columns 233 angled from upper left to lower right between surfaces 223, 227. Columns 229, 231, 233 are comprised of fiber bundles generally labeled 235 in holes generally labeled 237. Extending from columns 229, 231, 233 and continuations of fibers in bundles 235 are segments 239, 241 243 on surfaces 223, 225, 227 respectively, which reach between same type columns (e.g. columns 229) in a row. When core 221 is used to produce a cored composite structure, holes 237 with bundles 235 typically fill with polymer and segments 239, 241, 243 form either primary or secondary bonds, depending on production process, with skins sections. Bonded fiber-polymer-composite columns 229, 231 are capable of transferring forces between skin sections on surfaces 223, 225, and bonded fiber-polymer-composite columns 233 are capable of transferring forces between skin sections on surfaces 223, 227.

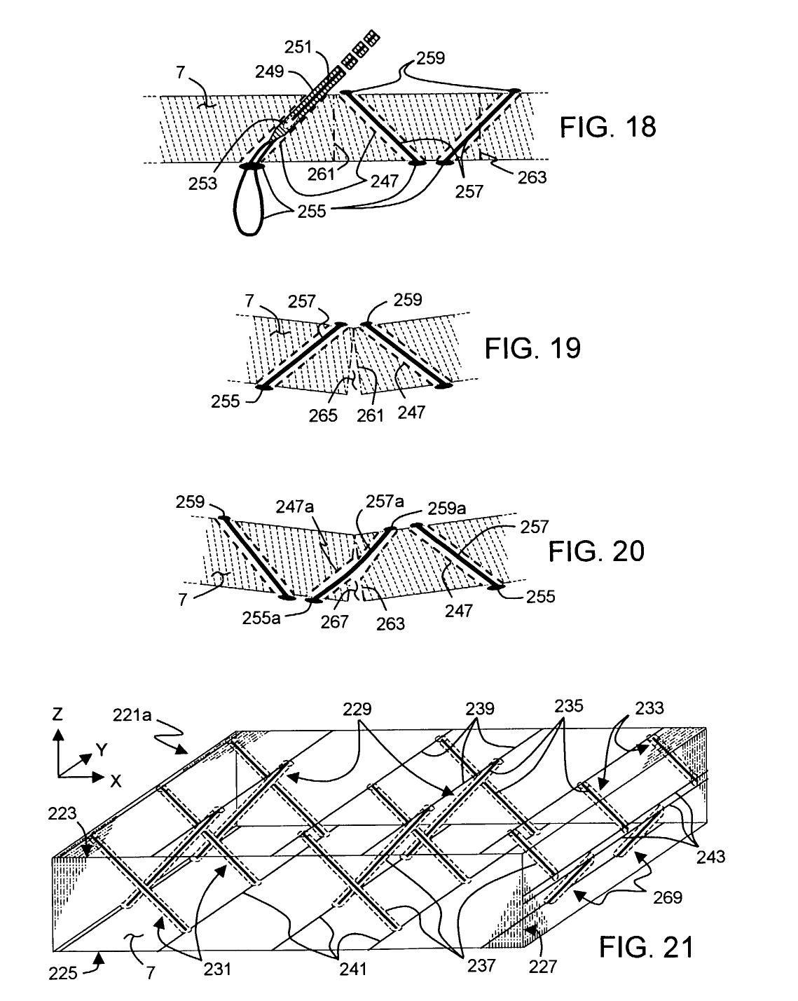

FIG. 18 shows a schematic drawing of one method for producing core 221 of FIG. 17. Material 7 moves incrementally along a production line into the figure, with displacements equal to spacing between equivalent unidirectional fiber-columns in a row, e.g. distance between columns 229 in Y-direction in FIG. 17. With material 7 stopped, a drill (not shown) forms a hole 247, and simultaneously needle 249 (shown withdrawing from core) with thread 251 passing through eye 253 enters a previously formed hole. Needle 249 and a mechanism (not shown but of type previously described) form loop 255, which locks previously formed loop 255 (drawn as an oval because loop is coming out of the figure), and places fiber bundle 257 in hole 247. The figure also shows other bundles 257, in various holes 247, with associated fiber segments 259 on upper surface and loops 255 on lower surface of material 7 (also drawn as ovals to represent fibers perpendicular to the figure).

If core of FIG. 18 is to be used only in flat structures, then loops 255 can be tensioned so that length of continuous thread 251 in the loops equals twice distance between bundles 257. However, if the core may be used in a curved-surface structure, then length of thread 251 in loops 255 needs determined. If the core is bent in direction of loops 255, i.e. bend radius in Y-Z plane of core 221 in FIG. 17, then as in discussion of FIG. 9, loop 255 length must be sufficient to allow the core to bend to designed minimum radius in that plane. If the core must also bend in plane shown in FIG. 18 (X-Z plane of FIG. 17), since holes 247 and bundles 257 are not perpendicular to material 7 surfaces, additional length of thread 251 in loops 255 may be required as will now be explained.

FIG. 19 shows a schematic drawing of core of FIG. 18 bent at cut 261 to conform to a curved surface. While the bend opens gap 265, loops 255 need no additional length since the gap does not affect bundles 257, loops 255 or segments 259. FIG. 20, however, shows a schematic drawing of core of FIG. 18 bent at cut 263. (In FIG. 18, cut 263 is made before fiber bundles 257 are placed in holes 247 sectioned by the cut.) The bend of FIG. 20 opens gap 267 such that previous hole 247 with cut 263 in FIG. 18 becomes hole 247a which effectively includes a volume of gap 267 that is the transition between sections of the previous hole. The increased length of hole 247a increases length of bundle 257a needed between loop 255a and segment 259a. Hole 247a with bundle 257a, and therefore the column comprised of the hole and the bundle, is not straight. If gap 267 is sufficiently large, i.e. bend radius sufficiently small, column with hole 247a and bundle 257a is not unidirectional. A non-unidirectional column has impaired ability to transfer forces between skin sections of a cored composite structure. Hence, either bend radius should be limited to keep the column comprised of hole 247a and bundle 257a unidirectional, or there must be sufficient unidirectional fiber-columns not affected by core bend to meet the core's force-transfer requirements. In any case, loop 255a must have sufficient length to allow not only for bend in loop direction, but also for bend perpendicular to loop direction. Hence, total length of continuous thread 251 contained in any loop 255 of FIG. 18, or for appropriate segments 239, 241, 243 of FIG. 17 is determined by design limits of core bend at that loop location.

While FIGS. 19 and 20 show examples where FIG. 18 core is bent by being cut into sections, if core-material 7 can be shaped without sectioning, e.g. by heating, effect of bending still must be considered when designing fiber lengths in loops 255 of FIG. 18 or appropriate segments 239, 241, 243 of FIG. 17.

Referring again to FIG. 17, angled columns 229, 231, 233 make core 221 particularly effective in transferring shear forces in X-direction. However, there is typically no one unique design for core 221 because both physical and practical requirements must be considered. As an example, FIG. 21 shows a schematic drawing of an invention embodiment of core 221a that is similar to—and labeled same as—FIG. 17 embodiment, except that relative placements of columns 229, 231, 233 are changed, and columns 269 extending between surfaces 227, 225 are added. While cores 221 and 221a have essentially same number of columns 229, 231 per unit area of surfaces 223, 225, design selection might be decided based on cost or performance in a particular application. For any design, preferred minimum cross-section area of unidirectional fiber-columns 229, 231, 233, 269 is less than square of length of shortest line that can be drawn within respective columns between corresponding surfaces 223, 225, 227, and more preferred minimum cross-section area of 0.25 times preferred minimum cross-section area.

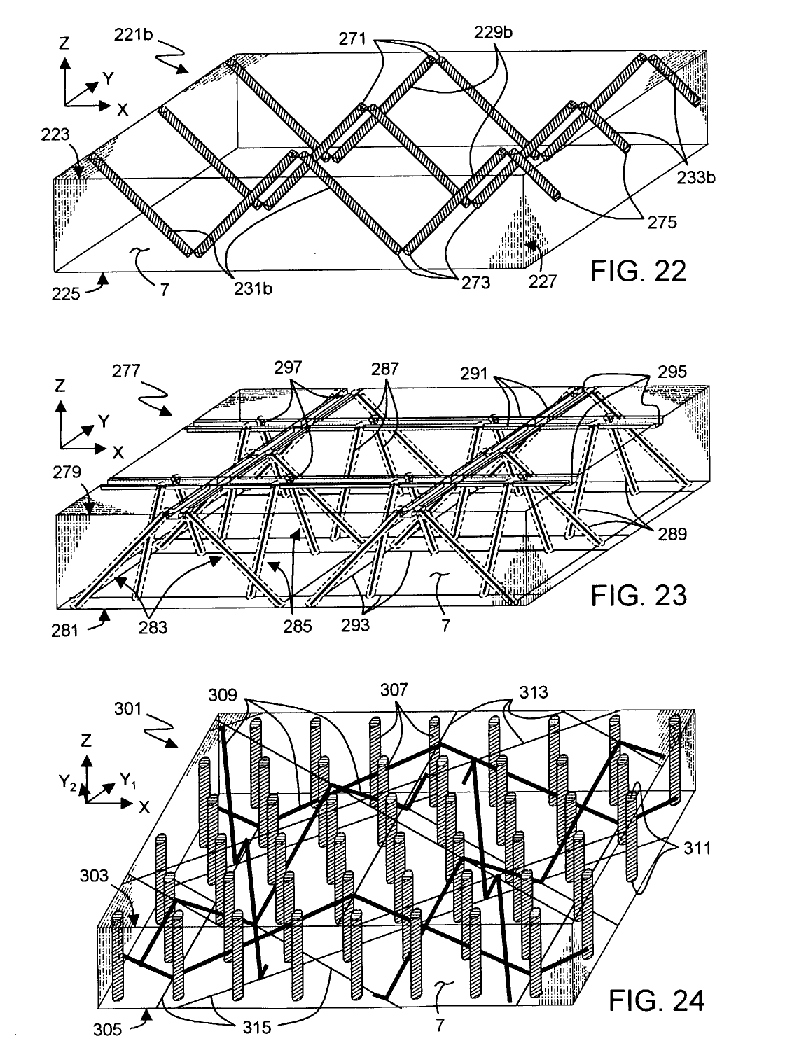

FIG. 18 shows only one method of producing an invention embodiment with non-perpendicular unidirectional fiber-columns, however, any methods of FIGS. 2, 4, 6, 8, 9, 11, 13 or other appropriate methods may be used to produce similar embodiments. For example, FIG. 22 shows a schematic drawing of an invention embodiment with non-perpendicular columns that are fiber-polymer-composite. Core 221b includes columns 229b, 231b, 233b inserted by method of FIG. 2. Due to angle of columns 229b, 231b, 233b to surfaces 223, 225, 227, small column-volumes 271, 273, 275 extend beyond respective surfaces. When core 221b is used in a cored composite structure, volumes 271, 273, 275 bond to—and becoming part of—skin sections, enabling columns 229b, 231b, 233b to transfer forces between skin sections.

For all cores with non-perpendicular columns, but especially for cores with composite columns, e.g. core 221b of FIG. 22, if core may be used in a curved-surface cored composite structure, technique and practice of bending the core is a practical requirement that must considered when designing column placement.

FIG. 23 shows a schematic drawing of another invention embodiment. Core 277 with opposite and parallel surfaces 279, 281 includes array of unidirectional fiber-columns with columns 283 angled in X-direction and columns 285 angled in Y-direction. Columns 283, 285 are comprised of fiber bundles, generally labeled 287, in holes, generally labeled 289, which are connected by fiber segments 291, 293 on core surfaces 279, 281 respectively. Core 277 also includes core-material that is comprised of previously described core material 7 and channels 295, which are open volumes in material 7. That is, together core-material 7 and channels 295 define parallel surfaces 279, 281, and position and allow columns 283, 285 to bond to—and to become capable of transferring force between—cored-composite-structure skin sections. In particular, channels 295 aid filling columns 283, 285 with polymer during cored composite structure production by intersecting holes 289 of columns 283, 285 at intersections 297, so that each column is in fluid communication with a channel. When core 277 is used in a cored composite structure, a production method is typically used, e.g. a vacuum assisted resin transfer molding process or a pressurized pump process, which urges polymer along channels 295 and into holes 289 to create unidirectional fiber-polymer composite columns and to bond, typically with primary bonds, segments 291, 293 to skin sections. When a core composite structure is produced in this manner, polymer in channels 295 hardens and is part of the structure's core-material.

FIG. 24 shows a schematic drawing of another invention embodiment. Core 301, with opposite and parallel surfaces 303, 305, is comprised of core-material 7 and array with unidirectional fiber-columns 307 perpendicular to—and unidirectional fiber-columns generally labeled 309 at angle other than 900 to—the surfaces. Perpendicular columns 307 are fiber-polymer composite with ends 311 positioned so that the columns bond to skin sections when core 301 is used in a cored composite structure. Angled columns 309 are all-fibers, and segments, generally labeled 313, 315 on core surfaces 303, 305 respectively, are extensions of column fibers that bond columns 309 to skin sections when core 301 is used in a cored composite structure. Columns 307, positioned in a hexagonal array, are of particular benefit for transferring compressive and tensile forces, and columns 309, positioned on three axes of columns 307 hexagonal array, are of particular benefit for transferring shear forces in a cored composite structure.

Core 301 can be produced using methods described in conjunction with embodiment shown in FIG. 1 for columns 307, and using methods described in conjunction with embodiment shown in FIG. 12 with the fine needle at appropriate angle for columns 309. Core 301 can also be produce by other appropriate methods.

An invention embodiment similar to core 301 of FIG. 24 can have unidirectional fiber-columns similar to columns 307 of core 301, but comprised of fiber bundles in holes that can fill with polymer when the core is used in a cored composite structure. Another similar embodiment can have only columns 309, which transfer both shear and tensile forces when used in a cored composite structure. In an embodiment where only unidirectional fiber-columns 309 are included, core-material 7 could include non-fiber columns, e.g. all polymer columns, to enhance compressive force transferring capability of the material.

As with any embodiment with angled columns, if core 301 is to be used in a curved-surface core composite structure, particular design attention must be paid to column placement, both physically and practically, with respect to technique and practice of producing the structure. Preferred minimum cross-section area of perpendicular columns 307 is less than core 301 thickness squared, and of columns 309 is less than square of length of shortest line that can be drawn within the columns between surfaces 303, 305. More preferred minimum cross-section areas of columns 307 and 309 are 0.25 times preferred cross-section areas of each.

While arrays of unidirectional fiber-columns shown and described in previous invention embodiments have independent columns that do not intersect, present invention is not limited to independent columns.

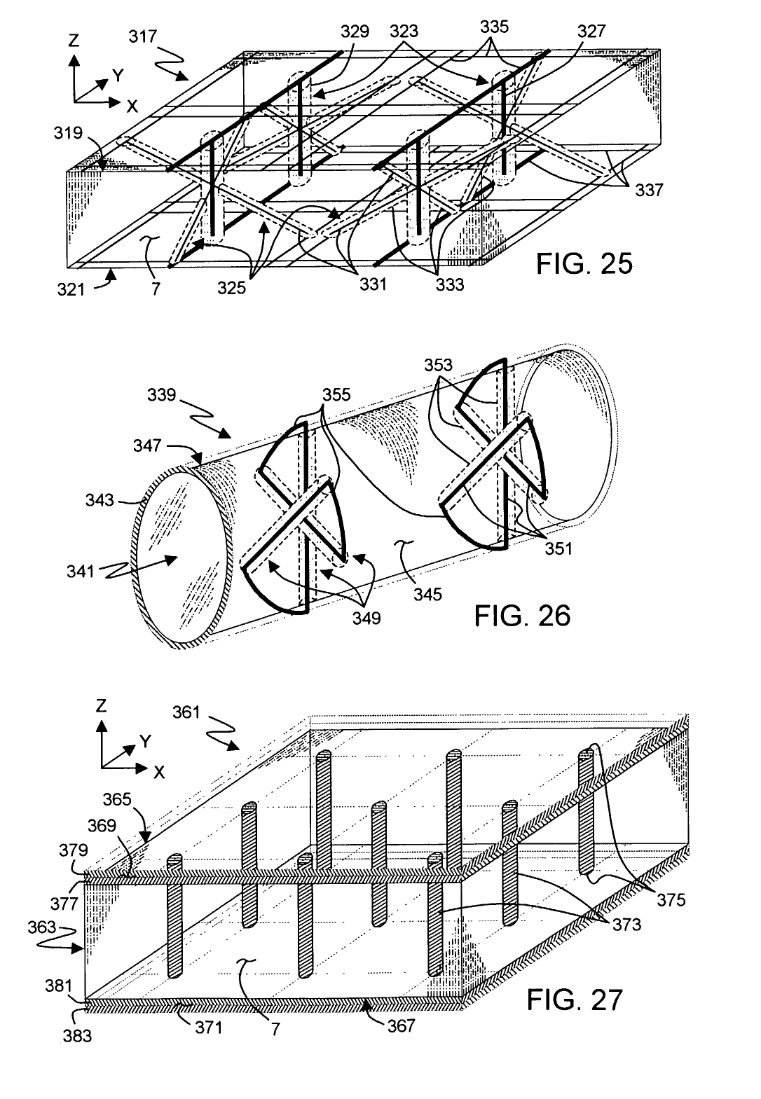

FIG. 25 shows a schematic drawing of another invention embodiment. Core 317, with parallel surfaces 319, 321, is comprised of core material 7 and array of intersecting unidirectional fiber-columns 323, 325. Columns 323 are relatively large diameter columns that are perpendicular to surfaces 319, 321 and are comprised of fiber bundles 327 in holes 329. Columns 325 are smaller diameter columns that are not perpendicular to surfaces 319, 321 and are comprised of fiber bundles 331 in holes 333. Segments, generally labeled 335, 337 on surfaces 319, 321 respectively, are extensions of fibers from bundles 327, 331 that, when core 317 is used in a cored composite structure, bond to—and become part of—skin sections, thereby bonding columns 323, 325 to skin sections. Columns 323 are of particular benefit in transferring compressive and tensile forces and columns 325, aligned in biaxial array, are of particular benefit in transferring shear forces.

Core 317 can be produced by first forming, e.g., by drilling or punching, holes 329, 333 for intersecting columns 323, 325 respectively and then placing, e.g. by sewing, bundles 327, 331 into respective holes. Core 317 can also be produced using needles to both form holes 329, 333 and place bundles 327, 331 respectively in single operation, e.g. with method similar to that shown in FIG. 6. With use of needles, columns 323 would typically be formed first with holes 329 and bundles 327 designed to allow needles for smaller holes 333 and bundles 331 to pass through column 323 without damaging bundle 327. Fiber content of bundles 327, 331 may vary not only in number of fibers, but also in fiber type, e.g. carbon versus glass, and/or in fiber diameter to allow the bundles to be appropriate size and flexibility to coexist at column intersection while meeting physical performance requirements.

As described in embodiment of FIG. 1, core-material 7 is intended to remain in a produced cored composite structure. Present invention, however, is not limited to core-material that remains in the cored composite structure once core surface sections are defined and the unidirectional fiber-columns are bonded to—and capable of transferring forces between—skin sections.

FIG. 26 shows a schematic drawing of another invention embodiment. Structure 339, which is for a tube-shape cored composite structure with single skin, is comprised of core 341 and fiber layer 343. Core 341 is comprised of cylindrical core-material 345, with curved surface 347, and array of unidirectional fiber-columns 349. Material 345 is intended for substantial removal from a cored composite structure after columns 349 are bonded to fiber-reinforced-polymer skin sections. That is, while material 345 is appropriate for pressures, temperatures and chemicals of placing skin sections on core surface sections and bonding columns to skin sections during cored-composite-structure production; the material can, by chemical, thermal, radiation or other appropriate means, be turned into a fluid i.e. liquid, gas and/or particulate, that flows through a structure opening, e.g. flat ends of core 341, to be substantially removed, leaving placed skin sections and bonded fiber-columns intact. Columns 349 are comprised of fiber bundles 351 in holes 353. Columns 349 are in groups of three on diameters of surface 347 at 1200 relative angles, with center column intersecting portion of two outer columns on axis of core 341 (intersection area not shown) such that holes 353 of the three columns are in fluid communication. Segments 355 are extensions of fibers in bundle 351 that connect bundles within a group of columns 349 and that hold layer 343 onto surface 347. When structure 339 is used in a cored composite structure, a production method should be used that allows holes 353, layer 343 and any other fiber layers to fill with polymer, and when the polymer is hardened, that allows material 345 to be substantially removed such that open volume remains. The remaining open volume can be filled with ambient gas, can be a filled with a particular gas or no gas and sealed, or can be used for communicating other material through the core. In general, however, material 345 is removed to reduce structure weight, and in any case, polymer-filled composite columns 349, which bond together and bond to skin sections in groups of three, are capable of transferring forces for structure stiffness.

Previous figures show and describe features and embodiments of present invention in terms of a core, or of a structure containing a core and one or more fiber layers, for use in cored composite structures. Features and embodiments of present invention can also be shown and described in terms of a core in use in cored composite structures; following three figures are examples.

FIG. 27 shows a schematic drawing of another embodiment of present invention. Cored composite structure 361 is comprised of core 363 with opposite and parallel surfaces 365, 367 that extend in X-Y planes and fiber-polymer composite skins 369, 371 respectively on the core surfaces. Note: in many cored composite structures, core 363 would be enclosed as skins 369, 371 would be brought together where the core ends near structure edges, sharp bents or at other structure locations. Hence, cored composite structure 361 can be section of larger composite structure. Further note: in this and following figures, skins are drawn clear, except for closest exposed edges, to allow viewing of invention details, and some fine lines are added to aid in locating where skin and core features meet. With continued reference to FIG. 27, core 363 is comprised of core-material 7 and array of unidirectional fiber-columns 373 that extend perpendicularly between core surfaces 365, 367 and are bonded to sections of skins 369, 371. Columns 373 are comprised of fibers in hardened polymer that can transfer tensile, compressive and shear forces between ends 375, which are even with and part of core surfaces 365, 367. Core 363 with columns 377 can be produced by any method described in conjunction with embodiments of FIGS. 1, 5, 7 and 14. That is, columns 377 can be fiber-polymer composites in material 7 before structure 361 is produced or can be fiber bundles in holes through material 7 that are filled with polymer as part of the structure production process. Columns 377 can contain fibers that reach only to ends 375 like, for example, column 21 of FIG. 2, and are bonded by secondary bonds to skins 369, 371. Columns 377 can contain fibers that extend beyond ends 375 like, for examples, column 35 of FIG. 3, columns 67 of FIG. 5 or columns 107 of FIG. 7, and are bonded by either primary or secondary bonds to—and part of—skins 369, 371. Columns 377 can contain fibers that do not extend to ends 375 like, for example, column 31 of FIG. 3, but where polymer and possibly sections of fibers extending from skins 369, 371, fill the ends during production of structure 361 to bond the columns to the skins by secondary bonds. Skins 369, 371 are each comprised of two fiber layers 377, 379 and 381, 383 respectively, and any fibers that extend beyond ends 375 from columns 373, in hardened polymer. In addition to columns 373 being bonded to sections of skins 369, 371, material 7 is also bonded to the skin sections and provides force transfer capability between the skins. That is, together material 7 and columns 373 transfer forces between skins 369, 371 so that, if the skins are uniformly pushed together, the material and columns transfer compressive force, if the skins are uniformly pulled apart, the material and columns transfer tensile force, and if the skins move in opposite directions in X-Y plane, the material and columns transfer shear force. Typically, forces applied to structure 361 are quite complex and forces transferred by material 7 and columns 373 between sections of skins 369, 371 vary as a function of location within the structure.

To design cored composite structure 361 for an optimum performance, e.g. minimum weight, knowledge is needed of a particular application's physical and practical requirements, of physical properties and bond strengths of potential skins 369, 371, core-materials 7 and unidirectional fiber-columns 373, and of potential processes for producing the cored composite structure. Preferred minimum cross-section area of perpendicular unidirectional fiber-columns 373 is less than core 363 thickness squared, and more preferred minimum cross-section area is less that 0.25 times preferred minimum cross-section area. With proper design, bonded unidirectional fiber-columns 377 substantially improve at least one property of cored composite structure 361 relative to a structure where same material 7 is used without the columns.

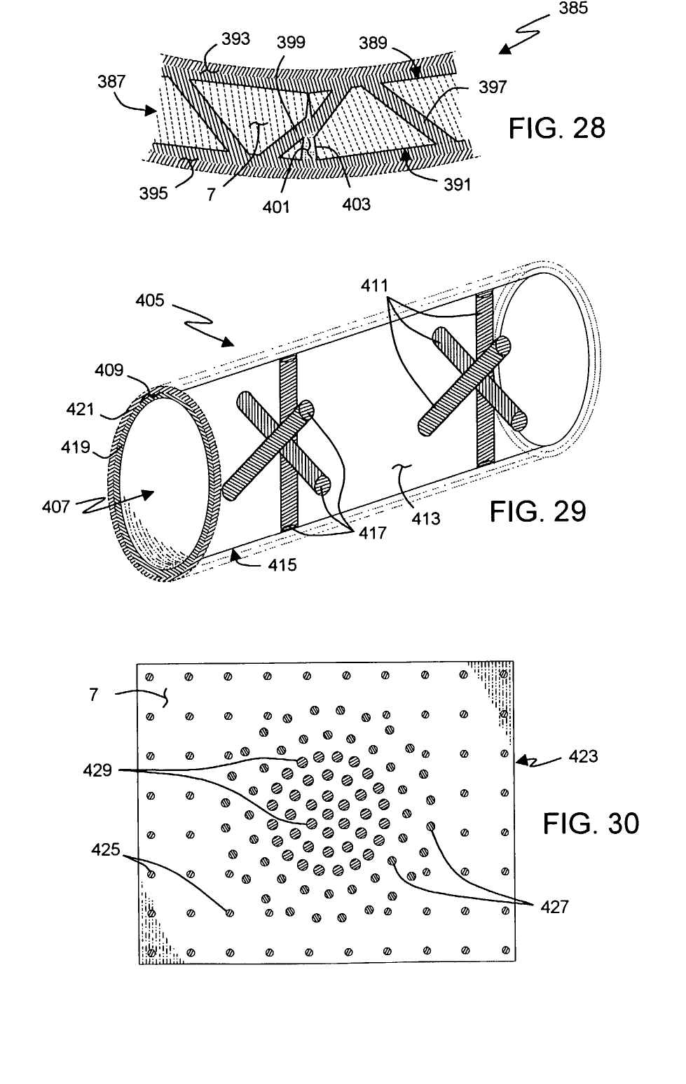

FIG. 28 shows a schematic drawing of another embodiment of present invention. Cored composite structure 385 has curved surfaces and is comprised of core 387 and fiber-polymer composite skins 393, 395 on core surfaces 389, 391 respectively. Core 387 is made by method shown of FIG. 18 and is bent in manner shown in FIG. 20. Core 387 includes array of unidirectional fiber-polymer composite columns 397, 399. Core 387 also includes core-material that is comprised of core-material 7 and polymer in gap 401 at cut 403. Columns 397, 399, material 7 and polymer in gap 401 are bonded to skins 393, 399 so that together the columns and core-material can transfer tensile, compressive and/or shear forces between the skins. While in an ideal composite structure 385, column 399 would be straight, even bent column 399 is still unidirectional and is designed to transfer required compressive, tensile and shear forces between skins 393, 395 of structure 385.

Another embodiment of a curved-surface cored composite structure with a core made by method of FIG. 18 could be shown where the core is bent without sectioning, e.g. by heating. The embodiment would be drawn similar to composite structure 385 of FIG. 28 except the core-material would only be material 7, since there would be no gap 401, and all three unidirectional fiber columns would have uniform-bend that is essentially one-third the relatively non-uniform-bend of column 399 of structure 385.

Another embodiment of a curved-surface cored composite structure similar to structure 385 could be shown with three straight columns. Core for this embodiment could be bent to appropriate shape before unidirectional fiber-columns are formed or inserted.

FIG. 29 shows a schematic drawing of another embodiment of present invention. Tube-shape cored composite structure 405 is comprised of core 407 and skin 409. Core 407 is comprised of array of unidirectional fiber-polymer composite columns 411, open volume 413 that remains inside skin 409 when core-material was substantially removed, and any residual core-material (none shown). That is, during structure 405 production, once core-material, e.g. core-material 345 of FIG. 26, defined core surface 415 (inverse of inside surface of skin 409) and held columns 411 in position to bonded to—and to became capable of transferring forced between—sections of skin 409, the core-material that filled volume 413 was turned to fluid by appropriate means and removed through ends of structure 405. Skin 409 and columns 411 are left intact, ambient gas fills open volume 413, and the core-material removal-efficiency determines whether core-material residue remains on inside surface of the skin or on the columns. Column ends 417 are bonded to skin 409, which is comprised of two fiber layers 419, 421 and fibers that extend beyond the column ends in a hardened polymer. Columns 411, which are in groups of three with center column intersecting portion of two outer columns such that polymer bonds the columns, are designed to transfer stiffening forces of structure 405.

Previously shown and discussed invention embodiments have relatively uniform arrays of unidirectional fiber-columns. Present invention arrays, however, do not need to be uniform.

FIG. 30 shows a schematic drawing of another invention embodiment. Core 423 is comprised of core-material 7 and array of unidirectional fiber-columns 425, 427, 429 perpendicular to a core surface (only column ends visible in this surface view). Columns 425, 427, 429 are fiber-polymer composite. Columns 425, aligned in square pattern on periphery of columns 427, 429, have relatively small diameter, i.e. size, and large spacing between columns. Columns 427, aligned in circular pattern around columns 429, have larger diameter and closer spacing than columns 425. Columns 429, aligned in circular pattern in center of core 423, have largest diameter and closest spacing of columns 425, 427, 429.

Core 423 is of particular benefit in a cored composite structure where equipment is mounted, by through-bolting, over columns 429. Larger, more closely spaced columns 429 provide additional compressive force transferring capability. For performance of practical reasons, a similar invention embodiment could use same-diameter unidirectional fiber-columns where fiber content varies by location in the array. Columns in high-compressive-load center could have, for example, the highest compressive-strength fibers and/or the highest fiber concentration to meet modulus and strength requirements. Same-diameter outer columns in the square pattern could have, for example, the lowest compressive-strength fibers and/or the lowest fiber concentration to meet modulus and strength requirements.

In general, cores that meet physical and practical requirements of a particular cored-composite-structure application can be designed and produced, using appropriate methods and equipment, with arrays that have unidirectional fiber-columns that vary in size, shape, spacing, fiber content, angle relative to core surface sections, and type, e.g. fiber-polymer composite or all-fiber, as a function of position in the array. While there is typically no one unique design of a core/cored-composite-structure for a particular application, in all designs preferred minimum cross-section area for each unidirectional fiber-column is less than square of shortest line that can be drawn within the column between at-least-perpendicular core surfaces, and more preferred minimum cross-section area is less than 0.25 times preferred minimum cross-section area. With proper design, unidirectional fiber-columns allow substantial improvement of at least one property of a cored composite structure, relative to a structure with the same core without the columns.

While particular embodiments of present invention have been shown and described, it is apparent that changes and modifications may be made therein without departing from the invention in its broadest aspects. Various combinations of these embodiments can be made. For example, a cored composite structure can have all-fiber unidirectional fiber-columns either with core-material remaining in—and of benefit to—the structure, or with core-material substantially removed from the structure. Other embodiments of the invention with different core or cored composite structure shapes or with different arrays or different unidirectional fiber-columns could have been shown. For example, an array can include both intersecting and independent unidirectional fiber columns. Other methods could have been shown for producing embodiments, or for conforming cores to curved-surface structure. For example, core-material can be formed to composite structure shape before the array of unidirectional fiber-columns is added. The aim of the appended claims, therefore, is to cover all such changes and modifications as fall within the true spirit and scope of the invention.

What is claimed is:

1. A core for a cored composite structure comprising:
an array of unidirectional fiber-columns that extend through the core between at-least-perpendicular core surface sections; and
a core-material, with the at-least-perpendicular core surface sections, that holds the columns and that allows the columns to bond to—and to become capable of transferring force between—fiber-reinforced-polymer skin sections placed on the core surface sections when a cored composite structure is produced.

2. The core of claim 1 wherein the core-material is capable of bonding to—and transferring forces between—and has average density less than the density of—fiber-reinforced-polymer skin sections placed on the core surface sections when a cored composite structure is produced.

3. The core of claim 1 wherein the core-material is capable of being turned into fluid for substantial removal after fiber-reinforced polymer skins sections are placed and unidirectional fiber-columns are bonded and capable of transferring forces when a cored composite structure is produced.

4. The core of claim 1 wherein the array comprises at least one unidirectional fiber-column that is selected from the group consisting of: fiber-polymer composite, all-fiber, all-fiber in a hole through the core-material that can become a fiber-polymer composite when a cored composite structure is produced.

5. The core of claim 1 wherein the core-material includes at least one channel that aids filling unidirectional fiber-columns, which are all-fiber in a hole through the core-material, with polymer when a cored composite structure is produced.

6. The core of claim 1 wherein the array includes unidirectional fiber-columns with fibers extending from at least one column end that are capable of bonding to—and becoming part of—a fiber-reinforced-polymer skin section when a core composite structure is produced.

7. The core of claim 6 wherein the fibers extending from the at least one column end hold a fiber layer on at least one core surface section so that the fibers are capable of bonding to—and becoming part of—a fiber-reinforced polymer skin section at a distance from the core surface when a cored composite structure is produced.

8. The core of claim 1 wherein the array includes unidirectional fiber-columns that vary in at least one of the following: size, shape, fiber content, angle relative to core surface sections, spacing between columns.

9. The core of claim 1 wherein the array includes intersecting unidirectional fiber-columns.

10. The core of claim 1 wherein the unidirectional fiber-columns have minimum cross-section area less than 0.25 times the square of the length of the shortest line that can be drawn within the column between core surface sections.

11. A core of a cored composite structure comprising:
an array of unidirectional fiber-columns bonded to—and capable of transferring force between—fiber-reinforced-polymer skin sections on at-least-perpendicular core surface sections; and
a core-material, with the at least perpendicular core surface sections, bonded to—and capable of transferring force between—and has average density less than the density of—skin sections on the core surface sections.

12. The core of claim 11 wherein the array comprises at least one unidirectional fiber-column that is selected from the group consisting of: fiber-polymer composite, all-fiber.

13. The core of claim 11 wherein the array includes unidirectional fiber-columns that vary in at least one of the following: size, shape, fiber content, angle relative to core surface sections, spacing between columns.

14. The core of claim 11 wherein the array includes intersecting unidirectional fiber-columns.

15. The core of claim 11 wherein the unidirectional fiber-columns have minimum cross-section area less than 0.25 times the square of the length of the shortest line that can be drawn within the column between core surface sections.

16. A core of a cored composite structure comprising:
an array of unidirectional fiber-columns bonded to—and capable of transferring force between—fiber-reinforced-polymer skin sections on at-least-perpendicular core surface sections;
open volume that remains when core-material that defined the at-least-perpendicular core surface sections and held the array of unidirectional fiber-columns while the columns were bonded to the fiber-reinforced polymer skin sections was substantially removed from the composite structure; and
any residual core material.

17. The core of claim 16 wherein the array comprises at least one unidirectional fiber-column that is selected from the group consisting of: fiber-polymer composite, all-fiber.

18. The core of claim 16 wherein the array includes unidirectional fiber-columns that vary in at least one of the following: size, shape, fiber content, angle relative to core surface sections, spacing between columns.

19. The core of claim 16 wherein the array includes intersecting unidirectional fiber-columns.

20. The core of claim 16 wherein the unidirectional fiber-columns have minimum cross-section area less than 0.25 times the square of the length of the shortest line that can be drawn within the column between core surface sections.
